(19) United States
(12) Patent Application Publication
(10) Pub. No.: US 2025/0209825 A1
(43) Pub. Date: Jun. 26, 2025

(54) INFORMATION PROCESSING DEVICE AND IN-VEHICLE DEVICE

(71) Applicant: TOYOTA JIDOSHA KABUSHIKI KAISHA, Toyota-shi (JP)

(72) Inventor: Yuhei OYA, Toyota-shi (JP)

(73) Assignee: TOYOTA JIDOSHA KABUSHIKI KAISHA, Toyota-shi (JP)

(21) Appl. No.: 18/814,712

(22) Filed: Aug. 26, 2024

(30) Foreign Application Priority Data
Dec. 22, 2023 (JP) 2023-217418

(51) Int. Cl. G06V 20/58; G06V 10/98

(52) U.S. Cl. CPC G06V 20/58; G06V 10/993

(57) ABSTRACT

The cloud server includes a reception unit that receives position information of an abnormal portion and image information of an abnormal portion from a vehicle that has detected an abnormal portion during traveling, an image processing unit that patterns (for example, a road depression, a falling object tire, falling object wood, and the like) the image information received by the reception unit, and a transmission unit that transmits the abnormal pattern patterned by the image processing unit or the pattern information indicating the abnormal pattern to a following vehicle that has detected the abnormal portion corresponding to the abnormal pattern.

### CROSS-REFERENCE TO RELATED APPLICATION

This application claims priority to Japanese Patent Application No. 2023-217418 filed on Dec. 22, 2023, incorporated herein by reference in its entirety.

### BACKGROUND

### 1. Technical Field

The present disclosure relates to an information processing device and an in-vehicle device.

### 2. Description of Related Art

Japanese Unexamined Patent Application Publication No. 2014-120110 (JP 2014-120110 A) proposes a travel support system. The travel support system detects a position of a visual line, a visual line circle, and a visual field area of a driver from a photographed image photographed with a driver camera. The travel support system detects a characteristic object in front in a direction of travel of a vehicle from a photographed image photographed with a front camera and characteristic object image information. The travel support system specifies a visual recognition mode of the driver to the characteristic object in front in the direction of travel of the vehicle based on each detection result. The travel support system performs guidance related to the characteristic object based on the specified visual recognition mode.

### SUMMARY

There is technology in which a system of a vehicle judges, from a detection result, what type of obstacle there actually is on a road, and depicts this object on a display unit. In this case, it is difficult to judge an abnormal portion such as an obstacle by a vehicle, and patterns of depiction icons of the vehicle are limited. Accordingly, there are many cases in which a situation depicted on a display is limited to one of several types, even if there are many situations.

Moreover, it is desirable to accurately judge abnormal content (for example, a type of obstacle, a type of road abnormality such as a depression or the like) of an abnormal portion by a vehicle, and to notify this abnormal content to an occupant.

The present disclosure has been made in consideration of this circumstance, and provides an information processing device and an in-vehicle device that are capable of accurately notifying abnormal content of an abnormal portion to an occupant of a vehicle.

An information processing device relating to a first aspect includes a reception unit that receives position information of an abnormal portion and image information of the abnormal portion from a vehicle detecting the abnormal portion when traveling, and

a transmission unit that patterns the image information received by the reception unit, and transmits an abnormal pattern of the patterned image information or pattern information representing the abnormal pattern along with the position information to a following vehicle of the vehicle detecting the abnormal portion.

According to the first aspect, in the reception unit, position information of an abnormal portion and image information of the abnormal portion are received from a vehicle detecting the abnormal portion when traveling. Also, in the transmission unit, image information received by the reception unit is patterned, and an abnormal pattern of the patterned image information or pattern information representing the abnormal pattern is transmitted along with the position information to a following vehicle of the vehicle detecting the abnormal portion. As a result of this, it becomes possible to accurately notify abnormal content of an abnormal portion to an occupant of a vehicle.

An information processing device relating to a second aspect has, in the information processing device relating to the first aspect, transmission of an abnormal pattern to the following vehicle in a next time or after prohibited when the abnormal portion is removed and the abnormal portion is not detected by the following vehicle.

According to the second aspect, an abnormal pattern being mistakenly displayed in a following vehicle can be prevented.

An information processing device relating to a third aspect has, in the information processing device relating to the first aspect or the second aspect, the transmission unit transmit an icon image in which the image information is patterned to the following vehicle as the abnormal pattern.

According to the third aspect, it becomes possible to increase a depiction pattern of an abnormality portion in a following vehicle.

An in-vehicle device relating to a fourth aspect includes

an information transmission unit that transmits image information representing a photographed image in which an abnormal portion is photographed and position information representing a position of the abnormal portion to an external device when the abnormal portion is detected by a detection unit that detects the abnormal portion in front of a vehicle, a pattern reception unit that receives an abnormal pattern in which the image information is patterned or pattern information representing the abnormal pattern from the external device along with the position information, and
a display processing unit that, when the abnormal pattern or the pattern information is received from the external device by the pattern reception unit, or when the abnormal portion is detected by the detection unit, displays the abnormal pattern received by the pattern reception unit or the abnormal pattern represented by the pattern information on a display unit at a position corresponding to a position of the abnormal portion detected by the detection unit.

According to the fourth aspect, abnormal content of an abnormality portion can be accurately notified to an occupant of a vehicle. Moreover, a correlation positional relationship between the abnormality portion and the vehicle can be displayed with good accuracy.

An in-vehicle device relating to a fifth aspect has, in the in-vehicle device relating to the fourth aspect,

the display processing unit display the abnormal pattern on the display unit based on a comparison result between the position information of the abnormal portion detected by the detection unit and the position information received by the pattern reception unit.

According to the fifth aspect, whether a detected abnormal portion is a received abnormality portion can be confirmed, and an improvement of a display accuracy of the abnormality portion becomes possible.

Note that, one aspect may be an information processing system that includes the information processing device relating to any one aspect of the first aspect to the third aspect and the in-vehicle device relating to the fourth aspect or the fifth aspect.

Moreover, one aspect may be a program for causing a computer to function as each unit of the information processing device relating to any one aspect of the first aspect to the third aspect. One aspect may be a program for causing a computer to function as each unit of the in-vehicle device relating to the fourth aspect or the fifth aspect.

According to the present disclosure described above, an information processing device and an in-vehicle device can be provided that are capable of accurately notifying abnormal content of an abnormal portion to an occupant of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of an information processing system according to the present embodiment;

FIG. 2 is a block diagram illustrating a configuration of a control unit of an in-vehicle device and a central processing unit of a cloud server;

FIG. 3 is a diagram for explaining an operation of each unit of the information processing system according to the present embodiment;

FIG. 4 is a diagram illustrating an example of display on a display unit;

FIG. 5 is a diagram for describing an operation of each unit when an abnormality is eliminated in the information processing system according to the present embodiment;

FIG. 6 is a flowchart illustrating an example of a flow of processing when abnormal data (image information and position information) is transmitted to a cloud server when an abnormality is detected in the in-vehicle device of the information processing system according to the present embodiment;

FIG. 7 is a flow chart illustrating an exemplary flow of a process performed by a cloud server when abnormal data (image information and position information) is transmitted from an in-vehicle device in the information processing system according to the present embodiment; and

FIG. 8 is a flowchart illustrating an example of a flow of processing performed by the in-vehicle device when a result of patterning is transmitted from a cloud server in the information processing system according to the present embodiment.

### DETAILED DESCRIPTION OF EMBODIMENTS

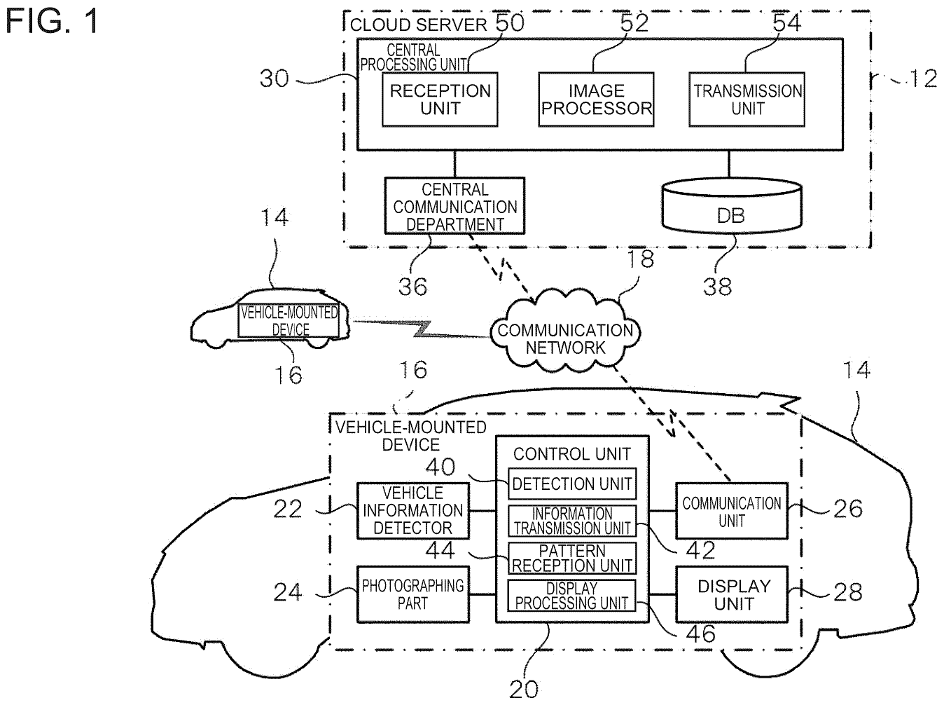

Exemplary embodiments of the present disclosure will be described in detail below with reference to the drawings. FIG. 1 is a block diagram illustrating a schematic configuration of an information processing system according to an embodiment.

In the information processing system 10 according to the present embodiment, an in-vehicle device 16 as an example of an in-vehicle device mounted on a vehicle 14 and a cloud server 12 as an example of an information processing device are connected via a communication network 18. In FIG. 1, two vehicles 14 are shown, but three or more in-vehicle devices 16 of the plurality of vehicles 14 are connected to the cloud server 12 via a communication network 18.

In the information processing system 10 according to the present embodiment, the cloud server 12 collects and accumulates image information representing photographed images captured by the plurality of vehicles 14 and vehicle information representing the state of each vehicle 14. Further, the cloud server 12 specifies the contents of the abnormal portion such as an obstacle or a depression on the road based on the accumulated information, and performs processing of transmitting the abnormal pattern representing the contents of the specified abnormal portion or the pattern information representing the abnormal pattern to the traveling vehicle.

The in-vehicle device 16 mounted on the vehicle 14 detects an abnormal portion from a photographed image in front, and transmits the position of the abnormal portion and the photographed image to the cloud server 12 when the abnormal portion is detected. Further, the in-vehicle device 16 receives the abnormality pattern or the pattern information transmitted from the cloud server 12, and determines whether the position received from the cloud server 12 corresponds to the detected position when the abnormal portion is detected in the front. Then, when both positions correspond to each other, a process of displaying an abnormality pattern received from the cloud server 12 or an abnormality pattern corresponding to the pattern information received from the cloud server 12 is performed.

Specifically, the in-vehicle device 16 includes a control unit 20, a vehicle information detection unit 22, an imaging unit 24, a communication unit 26, and a display unit 28.

The vehicle information detection unit 22 detects vehicle information related to the vehicle 14. As an example of the vehicle information, vehicle information such as position information of the vehicle 14, vehicle speed, acceleration, steering angle, accelerator operation amount, distance to an obstacle around the vehicle, and a route is detected. Specifically, the vehicle information detection unit 22 can apply a plurality of types of sensors and devices that acquire information indicating what kind of situation the surrounding environment of the vehicle 14 is. Examples of the sensor and the device include a sensor mounted on the vehicle 14 such as a vehicle speed sensor and an acceleration sensor, a GNSS (Global Navigation Satellite System) device, an in-vehicle communication device, a navigation system, an ultrasonic sensor, and a radar device. GNSS device receives GNSS signals from a plurality of GNSS satellites and positions the position of the own vehicle 14. As the number of receivable GNSS signals increases, GNSS device improves the accuracy of positioning. The in-vehicle communication device is a communication device that performs at least one of vehicle-to-vehicle communication with another vehicle 14 and road-to-vehicle communication with a roadside device via the communication unit 26. The navigation system includes a map information storage unit that stores map information. The navigation system performs a process of displaying the position of the host vehicle 14 on a map or guiding a route to a destination based on the position information obtained from GNSS device and the map information stored in the map information storage unit. Further, the radar device includes a plurality of radars having different detection ranges, detects an object such as a pedestrian or another vehicle 14 existing in the vicinity of the host vehicle 14, and acquires the relative position and the relative speed of the detected object and the host vehicle 14. Further, the radar apparatus incorporates a processing apparatus that processes a detection result of a peripheral object. The processing device excludes roadside objects such as noise and guardrails from the monitoring target on the basis of changes in relative positions and relative velocities with individual objects included in the latest plurality of detection results, and follows and monitors the pedestrian, the other vehicle 14, and the like as the monitoring target object. Then, the radar apparatus outputs information such as a relative position and a relative speed with respect to each monitoring target object. Note that the vehicle information detection unit 22 does not need to detect all the vehicle information, and may detect a part of the vehicle information.

In the present embodiment, the imaging unit 24 includes an outward-facing camera that captures an image of the outside of the vehicle and an inward-facing camera that captures an image of the vehicle cabin, but only the outward-facing camera may be used. The imaging unit 24 captures an image of the periphery of the vehicle such as the front by the outward-facing camera, and generates outward-facing moving image data representing a photographed image of the moving image as image information. In addition, the imaging unit 24 captures an image of a driver in the vehicle cabin using an inward-facing camera, and generates inward-facing moving image data representing a photographed image of the moving image as image information. For example, a drive recorder or the like can be used as the outward-facing camera, and a driver monitor camera or the like can be used as the inward-facing camera. The outward-facing camera may further capture an image of the periphery of at least one of the side and the rear of the vehicle 14.

The communication unit 26 establishes communication with the cloud server 12 via the communication network 18. The communication unit 26 transmits and receives, as data, image information obtained by photographing by the imaging unit 24 and information such as vehicle information detected by the vehicle information detection unit 22 as CAN (Controller Area Network).

The display unit 28 displays information to provide various types of information to the occupant. In the present embodiment, for example, information or the like provided from the cloud server 12 is displayed. The display unit 28 may be, for example, a combination meter or a display provided on an instrument panel.

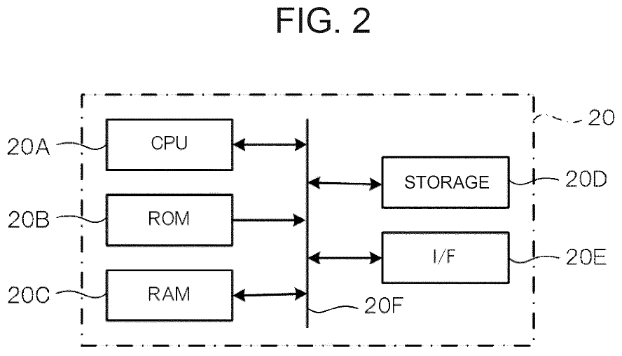

As shown in FIG. 2, the control unit 20 includes a typical microcomputer including a CPU (Central Processing Unit) 20A, ROM (Read Only Memory) 20B, RAM (Random Access Memory) 20C, a storage 20D, an interface (I/F) 20E, and a bus 20F.

The control unit 20 performs control to upload, to the cloud server 12, image information of a moving image representing a photographed image captured by the imaging unit 24 and vehicle information detected by the vehicle information detection unit 22 at the time of capturing the image. When the image information and the vehicle information are uploaded, identification information for identifying at least one of the vehicle and the driver is added and transmitted. The information for identifying the driver may be, for example, a photographed image obtained by photographing the driver, identification information of a smart key carried by the driver, or other information capable of identifying the driver.

In addition, the control unit 20 functions as a detection unit 40, an information transmission unit 42, a pattern reception unit 44, and a display processing unit 46 by CPU 20A expanding and executing a program stored in ROM 20B in a RAM 20C.

The detection unit 40 detects an abnormal portion (for example, a road depression, various obstacles, or the like) in front of the vehicle 14 based on at least one of a photographed image of the imaging unit 24 and a detection result of the vehicle information detection unit 22. For example, an abnormal portion may be detected from a photographed image by simple image recognition, or an abnormal portion may be detected by an ultrasonic sensor or a radar device.

When an abnormal portion is detected by the detection unit 40, the information transmission unit 42 transmits image information representing a photographed image obtained by capturing the front of the vehicle 14 by the imaging unit 24 and position information representing the position of the abnormal portion to the cloud server 12 as an external device. In the position information, the position information indicating the vehicle position detected by the vehicle information detection unit 22 is corrected to the position of the abnormal portion detected by the detection unit 40 and transmitted to the cloud server 12. For example, the direction and the distance of the abnormal portion are obtained from the vehicle position based on the radar device, the ultrasonic sensor, the photographed image, and the like, and the position information of the abnormal portion is derived by correcting the position information of the vehicle position.

The pattern reception unit 44 receives, from the cloud server 12, an abnormal pattern obtained by patterning the image information in the cloud server 12 or pattern information representing the abnormal pattern.

When the abnormal pattern or the pattern information is received from the cloud server 12 by the pattern reception unit 44 or when the abnormal portion is detected by the detection unit 40, the display processing unit 46 performs a process of causing the display unit 28 to display an abnormal pattern represented by the abnormal pattern or the pattern information received by the pattern reception unit 44 at a position corresponding to the position of the abnormal portion detected by the detection unit 40. Hereinafter, a case will be described in which the abnormal pattern is displayed on the display unit 28 when the pattern reception unit 44 receives the abnormal pattern or the pattern information by the push transmission from the cloud server 12. More specifically, the display processing unit 46 causes the display unit 28 to display the abnormality pattern based on the comparison result between the position information of the abnormality portion detected by the detection unit 40 and the position information received by the pattern reception unit 44. When the pattern reception unit 44 receives the pattern information, the display processing unit 46 may prepare a plurality of types of icon images representing the abnormal pattern in advance, and cause the display unit 28 to display an icon image corresponding to the pattern information.

On the other hand, the cloud server 12 includes a central processing unit 30, a central communication unit 36, and a DB (database) 38.

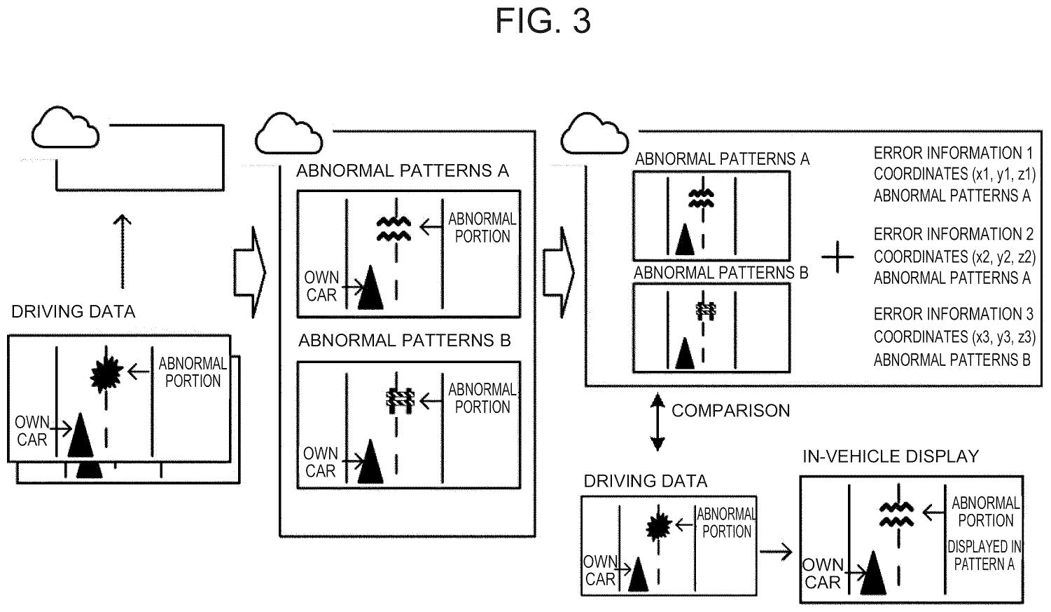

As illustrated in FIG. 3, the central processing unit 30 is constituted by a typical microcomputer including a CPU 30A, ROM 30B, a RAM 30C, a storage 30D, an interface (I/F) 30E, a bus 30F, and the like.

The central processing unit 30 functions as a reception unit 50, an image processing unit 52, and a transmission unit 54 by CPU 30A expanding and executing a program stored in ROM 30B in a RAM 30C.

The reception unit 50 receives the position information of the abnormal portion and the image information of the abnormal portion from the vehicles 14 that have detected the abnormal portion during traveling, and stores the position information in the database (DB) 38.

The image processing unit 52 patterns the image information received by the reception unit 50 (for example, road depression, falling object tire, falling object wood, and the like). For example, the image processing unit 52 specifies the abnormal portion and the type of the abnormal portion in the photographed image from the photographed image received by the reception unit 50 using a well-known image recognition model. Then, the corresponding abnormality pattern is selected from among the predetermined abnormality patterns in accordance with the contents of the abnormal portion. For example, an icon image such as a road depression icon, a falling object tire, or a falling object wood icon may be prepared in advance as an abnormal pattern, and an icon corresponding to the content of the specified abnormal portion may be selected as the abnormal pattern. Alternatively, an icon image may be generated from an image of the identified abnormal portion to form an abnormal pattern.

The transmission unit 54 transmits the abnormal pattern patterned by the image processing unit 52 or the pattern information representing the abnormal pattern to a following vehicle that has detected the abnormal portion corresponding to the abnormal pattern. Note that the transmission unit 54 transmits an icon image representing an abnormal pattern as the abnormal pattern, so that it is possible to increase the depiction pattern of the abnormal portion in the following vehicle.

The central communication unit 36 establishes communication with the in-vehicle device 16 via the communication network 18, and transmits and receives information such as image information and vehicle information.

The database 38 stores vehicle information such as image information and position information received by the reception unit 50 from the plurality of vehicles 14.

Next, the operation of each unit of the information processing system 10 according to the present embodiment will be described. FIG. 3 is a diagram for explaining an operation of each unit of the information processing system 10 according to the present embodiment.

In each vehicle 14, when the detection unit 40 detects an abnormal portion, image information representing a photographed image of the abnormal portion and position information of the abnormal portion are transmitted to the cloud server 12 as data during traveling. As a result, the cloud server 12 stores the image information of the abnormal portion detected by the detection unit 40 of each vehicle 14 and the position information in the database 38.

In the cloud server 12, a process of analyzing the image information collected from the vehicle 14 and patterning the abnormal portion is performed. For example, as shown in FIG. 3, the pattern is formed as an abnormal pattern A, an abnormal pattern B, or the like. Here, an example is shown in which an icon image corresponding to an abnormal portion is selected from among predetermined icons. Then, the cloud server 12 stores the patterned abnormal pattern together with the position information in the database 38. For example, as shown in FIG. 3, the data is stored in the database 38 such as abnormality information 1 (coordinates (x1, y1, z1), abnormality pattern A), abnormality information 2 (coordinates (x2, y2, z2), abnormality pattern A), abnormality information 3 (x3, y3, z3), and abnormality pattern B).

As a result, when the succeeding vehicle 14 travels at the position of the abnormal portion stored in the database 38 and the detection unit 40 of the succeeding vehicle 14 detects the abnormality, the cloud server 12 compares the image information of the abnormal portion and the abnormal pattern when the abnormal portion is detected during the traveling. The cloud server 12 determines an appropriate abnormal pattern. Specifically, the cloud server 12 compares the position information of the image information when the abnormal portion is detected with the position coordinates of the abnormal pattern stored in the database 38. When both positions correspond to each other, pattern information representing an abnormal pattern or an abnormal pattern is transmitted from the cloud server 12 to the vehicle 14 that has detected the abnormal portion. Thus, in the vehicle 14, the abnormal pattern is displayed on the display unit 28, and the occupant can recognize what abnormal portion is caused by the abnormal pattern. Therefore, it is possible to accurately notify the occupant of the vehicle 14 of the abnormality content of the abnormal portion.

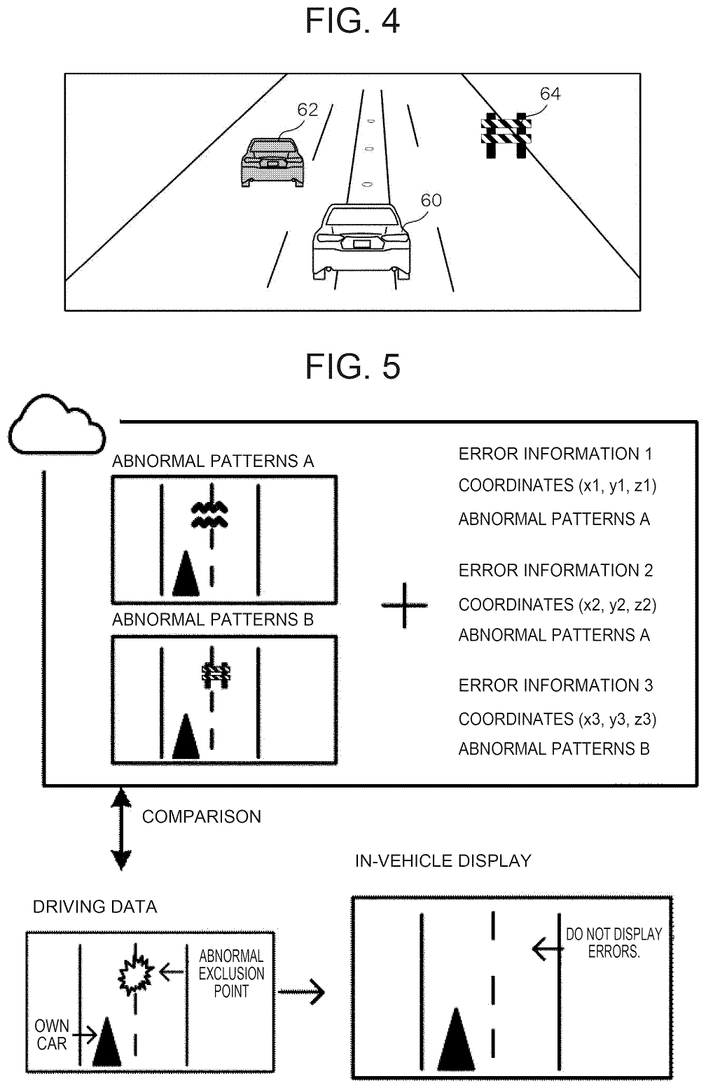

When the abnormal pattern is displayed on the display unit 28, a screen for displaying the surrounding environment in real time includes the relative position of the abnormal portion with respect to the vehicle 14 as a graphic. For example, as shown in FIG. 4, a vehicle icon 60 representing the host vehicle is displayed, a preceding vehicle icon 62 representing a preceding vehicle ahead is displayed, and an abnormal pattern icon 64 representing an abnormal pattern is displayed as an icon image. FIG. 4 is a diagram illustrating an example of display on the display unit 28.

When the abnormality is eliminated, as shown in FIG. 5, the data (image information and position information) at the time of traveling detected by the vehicle 14 that has passed through the position registered as the abnormal portion is compared with the abnormality information (image information and position information) stored in the cloud server 12. When it is determined that the abnormality has been eliminated, the abnormality pattern icon 64 is not displayed on the display unit 28 as shown in the in-vehicle display of FIG. 5. FIG. 5 is a diagram for explaining an operation of each unit in a case where an abnormality is eliminated in the information processing system 10 according to the present embodiment.

Next, specific processing performed by each unit of the information processing system 10 according to the present embodiment will be described.

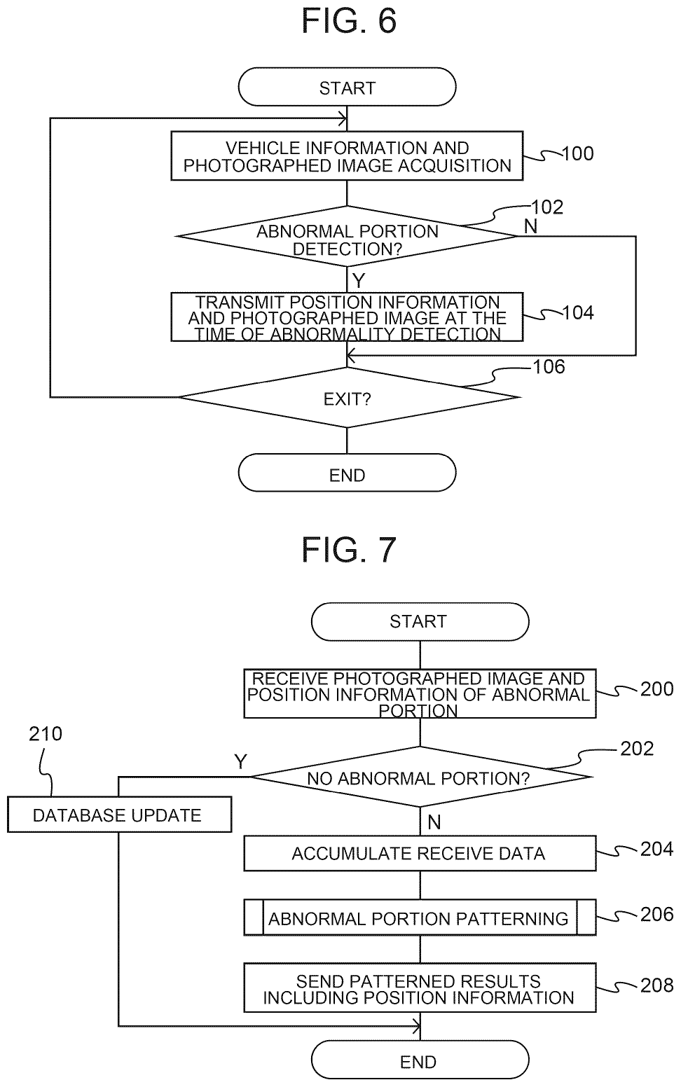

First, a process for transmitting abnormality data (image information and position information) to the cloud server 12 when an abnormality is detected in the in-vehicle device 16 of the vehicle 14 will be described. FIG. 6 is a flowchart illustrating an example of a flow of processing when abnormal data (image information and position information) is transmitted to the cloud server 12 when the abnormality is detected in the in-vehicle device 16 of the information processing system 10 according to the present embodiment. Note that the processing of FIG. 6 is started, for example, when an ignition switch (not shown) of the vehicle 14 is turned on.

In step 100, CPU 20A acquires the vehicle-information and the photographed images, and the process proceeds to step 102. That is, the vehicle information detected by the vehicle information detection unit 22 and the image information representing the photographed image captured by the imaging unit 24 are acquired.

In step 102, it is determined whether or not CPU 20A has detected an abnormal portion. For example, the determination determines whether or not the detection unit 40 has detected an abnormal portion (for example, a road depression, various obstacles, or the like) in front of the vehicle 14 based on at least one of the photographed image of the imaging unit 24 and the detection result of the vehicle information detection unit 22. If the determination is affirmative, the process proceeds to step 104, and if the determination is negative, the process proceeds to step 106.

In step 104, CPU 20A transmits the position information at the time of abnormality detection and the image information representing the photographed image to the cloud server 12, and the process proceeds to step 106. The position information transmitted to the cloud server 12 transmits, to the position information of the own vehicle, the position information of the abnormal portion obtained by correcting the direction and the distance of the obstacle detected by the detection unit 40.

In step 106, CPU 20A determines whether to terminate the process. For example, the determination is made as to whether or not an ignition switch (not shown) is turned off. If the determination is negative, the process returns to step 100 to repeat the above-described processing, and when the determination is affirmative, the series of processing ends.

Next, processing performed by the cloud server 12 when abnormal data (image information and position information) is transmitted from the in-vehicle device 16 will be described. FIG. 7 is a flowchart illustrating an example of a flow of processing performed by the cloud server 12 when abnormal data (image information and position information) is transmitted from the in-vehicle device 16 in the information processing system 10 according to the present embodiment. Note that FIG. 7 starts, for example, when abnormal data is transmitted from the in-vehicle device 16.

In step 200, CPU 30A receives the image information representing the photographed image of the abnormal portion and the position information of the abnormal portion from the in-vehicle device 16, and the process proceeds to step 202.

In step 202, it is determined whether CPU 30A has received photographed images without abnormal portions. The determination determines whether or not the photographed image and the position information having no abnormal portion has been received, and when there is an abnormal portion in the photographed image and the determination is negative, the process proceeds to step 204, and when there is no abnormal portion in the photographed image and the determination is affirmative, the process proceeds to step 210.

In step 204, CPU 30A accumulates the received data in the database 38 and proceeds to step 206. That is, the image information and the position information of the abnormal portion received from the in-vehicle device 16 are stored in the database 38.

In step 206, CPU 30A performs abnormal portion patterning, and the process proceeds to step 208. In the abnormal portion patterning, the image processing unit 52 patterns the image information received by the reception unit 50 (for example, road depression, falling object tire, falling object wood, and the like). For example, the image processing unit 52 specifies the abnormal portion and the type of the abnormal portion in the photographed image from the photographed image received by the reception unit 50 using a well-known image recognition model. Then, the corresponding abnormality pattern is selected from among the predetermined abnormality patterns in accordance with the contents of the abnormal portion.

In step 208, CPU 30A transmits the patterning including the position information to the subsequent vehicles 14 traveling at the abnormal portion and terminates the series of processes. In the present embodiment, the result of patterning by the push notification from the cloud server 12 is transmitted to the vehicle 14, but the present disclosure is not limited thereto, and may be pulled from the vehicle 14. That is, when an abnormal portion is detected on the vehicle 14 side, the request source vehicle 14 may receive a result of patterning from the cloud server 12 by making a transmission request to the cloud server 12.

On the other hand, in step 210, CPU 30A updates the anomaly data registered in the database 38, assuming that the anomaly has been eliminated, and ends the series of processes. For example, the next and subsequent transmission of the abnormality pattern to the vehicle 14 is prohibited, and the abnormality pattern and the position information of the abnormal portion registered in the database 38 are deleted without transmitting the abnormality pattern to the vehicle 14.

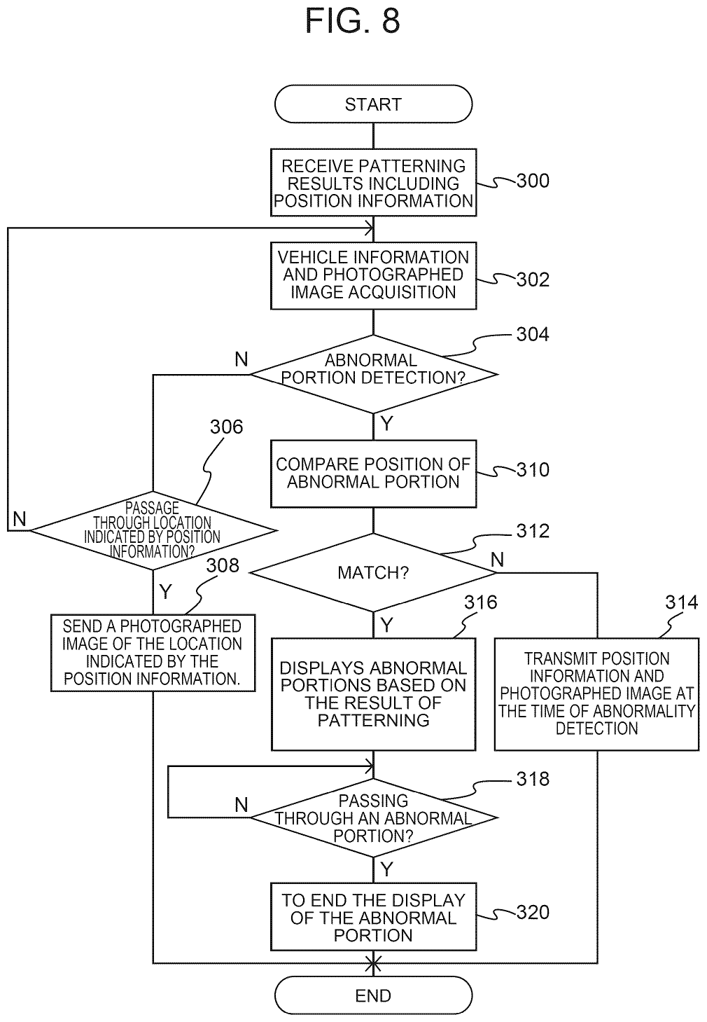

Next, processing performed by the in-vehicle device 16 when the result of patterning is transmitted from the cloud server 12 will be described. FIG. 8 is a flowchart illustrating an example of a flow of processing performed by the in-vehicle device 16 when a result of patterning is transmitted from the cloud server 12 in the information processing system 10 according to the present embodiment. Note that the processing of FIG. 8 is started when the result of patterning is transmitted from the cloud server 12.

In step 300, CPU 20A receives the patterned data including the anomaly data from the cloud server 12, and proceeds to step 302.

In step 302, CPU 20A acquires the vehicle-information and the photographed images, and the process proceeds to step 304. That is, the vehicle information detected by the vehicle information detection unit 22 and the image information representing the photographed image captured by the imaging unit 24 are acquired.

In step 304, it is determined whether or not CPU20A has detected an abnormal portion. For example, the determination determines whether or not the detection unit 40 has detected an abnormal portion (for example, a road depression, various obstacles, or the like) in front of the vehicle 14 based on at least one of the photographed image of the imaging unit 24 and the detection result of the vehicle information detection unit 22. If the determination is negative, the process proceeds to step 306, and if affirmative, the process proceeds to step 310.

In step 306, it is determined whether CPU20A has passed through the location represented by the position information. The determination determines whether or not the position of the abnormal portion notified from the cloud server 12 has passed without detecting the abnormality. If the determination is affirmative, the process proceeds to step 308, and if the determination is negative, the process returns to step 302 to repeat the above-described processing.

In step 308, CPU 20A transmits the photographed image of the location represented by the position information to the cloud server 12 together with the position information as the photographed image of the abnormal portion, and ends the series of processes. As a result, in the cloud server 12, the determination in step 202 is affirmative, and in step 210, the database 38 is updated assuming that the abnormality has been eliminated.

On the other hand, in step 310, CPU 20A compares the positions of the abnormal portions, and the process proceeds to step 312. That is, the position information transmitted from the cloud server 12 is compared with the position information of the abnormal portion where the abnormality is detected.

In step 312, CPU 20A determines whether the position of the abnormal portion matches. The determination determines whether or not an abnormality has been detected at a position corresponding to the position information transmitted from the cloud server 12. If the determination is negative, the process proceeds to step 314, and if affirmative, the process proceeds to step 316.

In step 314, CPU 20A transmits the position information and the photographed images at the time of anomaly detection to the cloud server 12, and ends the series of processes.

On the other hand, in step 316, CPU 20A displays the abnormal portion on the display unit 28 based on the patterning, and the process proceeds to step 318. That is, the display processing unit 46 displays the abnormal pattern received by the pattern reception unit 44 or the abnormal pattern represented by the pattern information on the display unit 28. As a result, the occupant can recognize what abnormal portion is caused by the abnormal pattern, and can accurately notify the occupant of the vehicle 14 of the abnormal content of the abnormal portion.

In step 318, it is determined whether or not CPU 20A has passed through the abnormal portion. Wait until the determination is affirmative, the process proceeds to step 320.

In step 320, CPU 20A terminates the display of the abnormal portion on the display unit 28 and terminates the series of processes.

As described above, in the information processing system 10 according to the present embodiment, the cloud server patterns the abnormality of the abnormal portion from the photographed image of the abnormal portion collected from the in-vehicle device 16, and transmits the patterned abnormality to the in-vehicle device 16. It is possible to accurately identify the abnormality content of the abnormal portion and notify the occupant of the abnormality.

In the above-described embodiment, the processing of the information processing system 10 has been described as an example, but the present disclosure is not limited thereto. A part of the processing of the cloud server 12 may be executed by the in-vehicle device 16. Partial processing of the in-vehicle device 16 may be executed by the cloud server 12. For example, in the above-described embodiment, when an abnormal portion is detected on the in-vehicle device 16 side, the position of the detected abnormal portion is compared with the position of the abnormal portion received from the cloud server 12. Alternatively, when an abnormal portion is detected, the position of the abnormal portion may be transmitted to the cloud server 12, and the position of the abnormal portion may be compared on the cloud server 12 side.

Although the processing performed by the information processing system 10 in each of the above-described embodiments has been described as software processing performed by executing a program, the present disclosure is not limited to this. For example, the process may be performed by hardware such as GPU (Graphics Processing Unit), ASIC (Application Specific Integrated Circuit), and FPGA (Field-Programmable Gate Array). Alternatively, the process may be performed by a combination of both software and hardware. Further, in the case of software processing, the program may be stored in various storage media and distributed.

Furthermore, the present disclosure is not limited to the above, and it goes without saying that the present disclosure can be variously modified and implemented within the scope thereof.

What is claimed is:

1. An information processing device, comprising:
a reception unit that receives position information of an abnormal portion and image information of the abnormal portion from a vehicle detecting the abnormal portion when traveling; and
a transmission unit that patterns the image information received by the reception unit, and transmits an abnormal pattern of the patterned image information or pattern information representing the abnormal pattern along with the position information to a following vehicle of the vehicle detecting the abnormal portion.

2. The information processing device according to claim 1, wherein transmission of an abnormal pattern to the following vehicle in a next time or after is prohibited when the abnormal portion is removed and the abnormal portion is not detected by the following vehicle.

3. The information processing device according to claim 1, wherein the transmission unit transmits an icon image in which the image information is patterned to the following vehicle as the abnormal pattern.

4. An in-vehicle device, comprising:
an information transmission unit that transmits image information representing a photographed image in which an abnormal portion is photographed and position information representing a position of the abnormal portion to an external device when the abnormal portion is detected by a detection unit that detects the abnormal portion in front of a vehicle;
a pattern reception unit that receives an abnormal pattern in which the image information is patterned or pattern information representing the abnormal pattern from the external device along with the position information; and
a display processing unit that, when the abnormal pattern or the pattern information is received from the external device by the pattern reception unit, or when the abnormal portion is detected by the detection unit, displays the abnormal pattern received by the pattern reception unit or the abnormal pattern represented by the pattern information on a display unit at a position corresponding to a position of the abnormal portion detected by the detection unit.

5. The in-vehicle device according to claim 4, wherein the display processing unit displays the abnormal pattern on the display unit based on a comparison result between the position information of the abnormal portion detected by the detection unit and the position information received by the pattern reception unit.
